(19) United States
(12) Patent Application Publication
(10) Pub. No.: US 2018/0156442 A1
(43) Pub. Date: Jun. 7, 2018

(54) LED Lamp with Expanded Illuminating Range

(71) Applicants: Ching-Hsiang Tseng, Taichung City (TW); Shao-Hui Cho, Taichung City (TW)

(72) Inventors: Ching-Hsiang Tseng, Taichung City (TW); Shao-Hui Cho, Taichung City (TW)

(21) Appl. No.: 15/365,993

(22) Filed: Dec. 1, 2016

(51) Int. Cl. F21V 29/80; F21V 3/04; F21V 29/67; F21V 21/26; F21V 17/12; F21V 23/00; F21S 8/04; F21V 8/00

(52) U.S. Cl. CPC F21V 29/80; F21V 3/04; F21V 29/673; F21V 21/26; F21Y 2115/10; F21V 23/001; F21S 8/04; F21V 23/005; G02B 6/0001; F21V 17/12

(57) ABSTRACT

An LED lamp includes a mounting seat, a circuit board mounted in the mounting seat, a plurality of primary LED lights mounted on the circuit board, a light permeable frame mounted on the mounting seat, and a shade mounted on the light permeable frame. The mounting seat is provided with a light guide face corresponding to an inner peripheral face of the light permeable frame. The light rays of the primary LED lights permeate through the shade and irradiate downward in a perpendicular manner, and are guided by the light guide face of the mounting seat, pass through the light permeable frame and are diffused and emitted sideward from the shade in an angle of one hundred and eighty degrees (180°) to expand the illuminating angle and range of the primary LED lights.

### BACKGROUND OF THE INVENTION

### 1. Field of the Invention

The present invention relates to an electronic appliance and, more particularly, to an LED (light emitting diode) lamp of a downlight type.

### 2. Description of the Related Art

A conventional downlight comprises a housing, a light emitting member mounted in the housing, and a shade mounted on the housing. When in use, the light rays of the light emitting member permeate through the shade and irradiate downward in a perpendicular manner. Thus, the light emitting member only has an illuminating angle of about one hundred and twenty degrees (120°). However, the light rays of the light emitting member cannot diffuse sideward from the periphery of the shade, thereby limiting the illuminating range and angle.

### BRIEF SUMMARY OF THE INVENTION

The primary objective of the present invention is to provide an LED lamp with an expanded illuminating range and angle.

In accordance with the present invention, there is provided an LED lamp comprising a mounting seat having a hollow portion, a circuit board mounted in the hollow portion of the mounting seat, a plurality of primary LED lights mounted on a bottom of the circuit board, a light permeable frame mounted on a periphery of the mounting seat, and a shade mounted on a bottom face of the light permeable frame. The mounting seat is provided with an outer stepped face. The mounting seat has a bottom provided with a light guide face corresponding to an inner peripheral face of the light permeable frame. The light permeable frame is provided with an inner stepped face secured on the outer stepped face of the mounting seat. The light rays of the primary LED lights permeate through the shade and irradiate downward in a perpendicular manner. At the same time, the light rays of the primary LED lights are guided by the light guide face of the mounting seat, pass through the light permeable frame and are diffused and emitted sideward from the shade in an angle of one hundred and eighty degrees (180°) to expand the illuminating angle and range of the primary LED lights.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an LED lamp in accordance with the first preferred embodiment of the present invention.

FIG. 2 is a perspective bottom view of the LED lamp in accordance with the first preferred embodiment of the present invention.

FIG. 3 is an exploded perspective view of the LED lamp in accordance with the first preferred embodiment of the present invention.

FIG. 4 is a front cross-sectional view of the LED lamp in accordance with the first preferred embodiment of the present invention.

FIG. 5 is a front cross-sectional view of the LED lamp in accordance with a second preferred embodiment of the present invention.

FIG. 6 is a front cross-sectional view of the LED lamp in accordance with a third preferred embodiment of the present invention.

FIG. 7 is a perspective view of an LED lamp in accordance with a fourth preferred embodiment of the present invention.

FIG. 8 is a perspective bottom view of the LED lamp in accordance with a fifth preferred embodiment of the present invention.

FIG. 9 is a perspective view of an LED lamp in accordance with a sixth preferred embodiment of the present invention.

FIG. 10 is a perspective bottom view of the LED lamp in accordance with a seventh preferred embodiment of the present invention.

FIG. 11 is an exploded perspective view of the LED lamp in accordance with the seventh preferred embodiment of the present invention.

FIG. 12 is a front cross-sectional view of the LED lamp in accordance with the seventh preferred embodiment of the present invention.

FIG. 13 is another front cross-sectional view of the LED lamp in accordance with the seventh preferred embodiment of the present invention.

FIG. 14 is a cross-sectional view of the LED lamp taken along line D-D as shown in FIG. 13.

FIG. 15 is a front cross-sectional view of the LED lamp in accordance with an eighth preferred embodiment of the present invention.

### DETAILED DESCRIPTION OF THE INVENTION

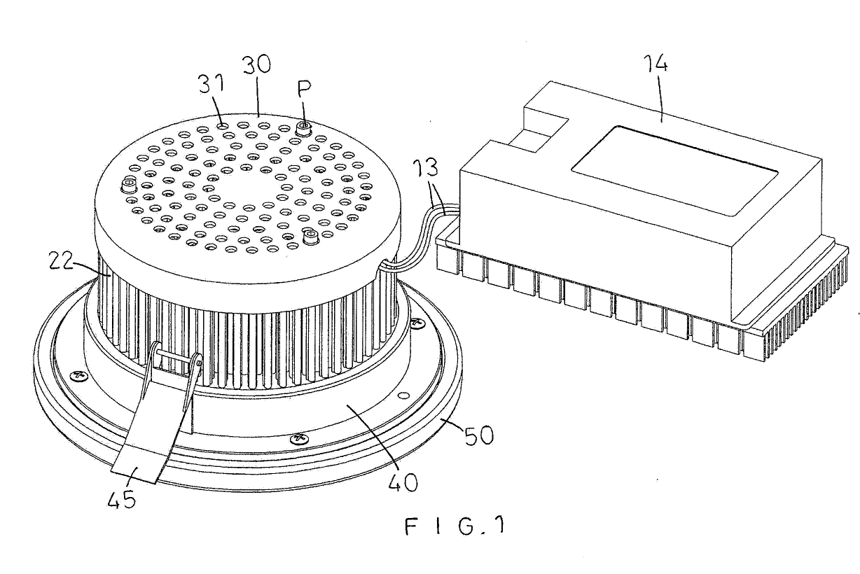

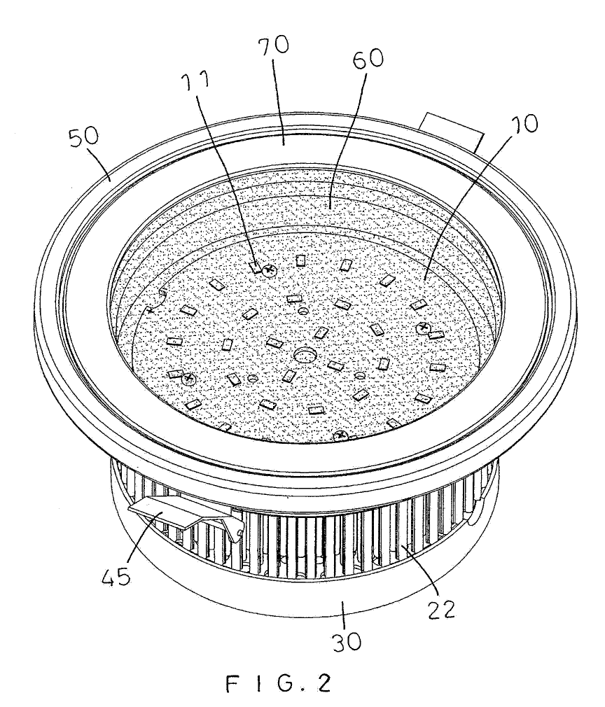

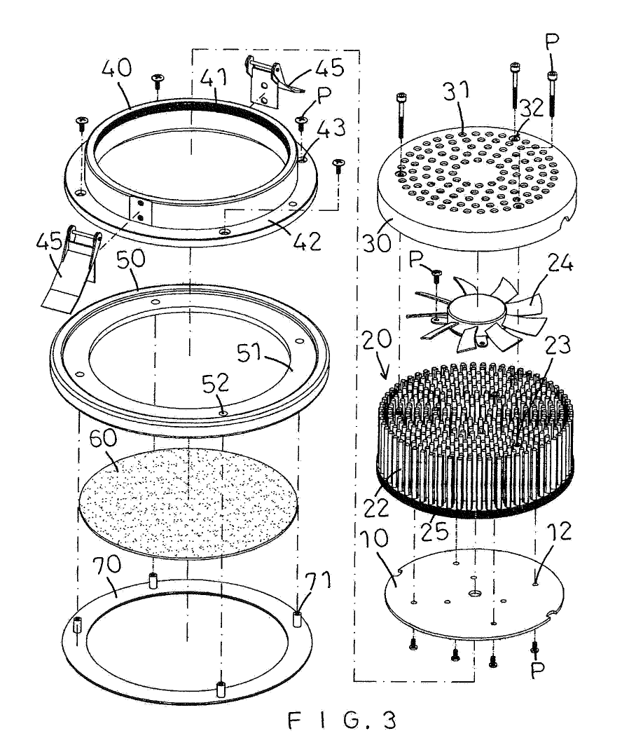

Referring to the drawings and initially to FIGS. 1-4, an LED lamp in accordance with the present invention comprises a mounting seat 40 having a hollow portion, a circuit board 10 mounted in the hollow portion of the mounting seat 40, a plurality of primary LED lights 11 mounted on a bottom of the circuit board 10, a light permeable frame 50 mounted on a periphery of the mounting seat 40, and a shade 60 mounted on a bottom face of the light permeable frame 50.

The circuit board 10 is connected with an LED driver 14 by two electric wires 13 to provide an electric power to the primary LED lights 11.

The mounting seat 40 is provided with an outer stepped face 42. The mounting seat 40 has a bottom provided with a light guide face 44 corresponding to an inner peripheral face of the light permeable frame 50. The light guide face 44 of the mounting seat 40 has an oblique shape.

The light permeable frame 50 has a hollow portion and is provided with an inner stepped face 51 secured on the outer stepped face 42 of the mounting seat 40 so that the mounting seat 40 and the light permeable frame 50 are combined integrally. Preferably, the light permeable frame 50 has an annular shape.

In the preferred embodiment of the present invention, the LED lamp further comprises a radiator 20 mounted on a top of the circuit board 10, and a heat radiating fan 24 mounted on the radiator 20. The radiator 20 includes a plurality of heat radiating columns 22 and a plurality of threaded columns 23. The heat radiating fan 24 is locked onto the threaded columns 23 of the radiator 20 by a plurality of screws “P” which extend through the heat radiating fan 24 and are screwed into the threaded columns 23 of the radiator 20. Thus, the heat energy produced by the circuit board 10 is conducted quickly by the heat radiating columns 22 of the radiator 20 and the hot air is blown outward by the heat radiating fan 24.

In the preferred embodiment of the present invention, the circuit board 10 is provided with a plurality of through holes 12. The radiator 20 is made of a high heat conductive material and has a bottom provided with a plurality of screw bores 21 corresponding to the through holes 12 of the circuit board 10. The circuit board 10 is locked onto the radiator 20 by a plurality of screws “P” which extend through the through holes 12 of the circuit board 10 and are screwed into the screw bores 21 of the radiator 20. The radiator 20 has an outer periphery provided with an external thread 25. The mounting seat 40 has an inner periphery provided with an internal thread 41 screwed onto the external thread 25 of the radiator 20.

In the preferred embodiment of the present invention, the LED lamp further comprises an air inlet ornament cover 30 mounted on the radiator 20. The air inlet ornament cover 30 is provided with a plurality of through holes 32 corresponding to the threaded columns 23 of the radiator 20. The air inlet ornament cover 30 is locked onto the threaded columns 23 of the radiator 20 by a plurality of screws “P” which extend through the through holes 32 of the air inlet ornament cover 30 and are screwed into the threaded columns 23 of the radiator 20. The air inlet ornament cover 30 has a surface provided with a plurality of air inlet holes 31 corresponding to the heat radiating fan 24, so that the heat radiating fan 24 draws ambient cold air through the air inlet holes 31 of the air inlet ornament cover 30 and blows the hot air outward. Thus, the air inlet ornament cover 30 prohibits interference of a foreign object, such as dust, insects and the like so that the air inlet ornament cover 30 has decorative and protective functions.

In the preferred embodiment of the present invention, the LED lamp further comprises two elastic plates 45 pivotally mounted on two opposite sides of the mounting seat 40. The mounting seat 40 is attached by the two elastic plates 45 to a support member, such as a lightweight steel or a wooden ceiling.

In the preferred embodiment of the present invention, the light permeable frame 50 is selectively made of light permeable material, such as acrylic PC.

In the preferred embodiment of the present invention, the shade 60 is made of translucent material and is formed with a foggy or matted face by a dispersant. Preferably, the shade 60 has a planar shape. The shade 60 is mounted on the hollow portion of the light permeable frame 50 so that the light rays of the primary LED lights 11 permeate through the shade 60 and irradiate downward in a perpendicular manner.

In the preferred embodiment of the present invention, the LED lamp further comprises a lower cap 70 mounted on a bottom of the shade 60. The outer stepped face 42 of the mounting seat 40 is provided with a plurality of through holes 43. The inner stepped face 51 of the light permeable frame 50 is provided with a plurality of apertures 52 corresponding to the through holes 43 of the mounting seat 40. The lower cap 70 has a hollow portion and is provided with a plurality of threaded tubes 71 extending through the apertures 52 of the light permeable frame 50. A plurality of screws “P” extend through the through holes 43 of the mounting seat 40 and are screwed into the threaded tubes 71 of the lower cap 70, to integrally combine the mounting seat 40, the light permeable frame 50, the shade 60 and the lower cap 70.

In the preferred embodiment of the present invention, the outer stepped face 42 of the mounting seat 40 and the inner stepped face 51 of the light permeable frame 50 are combined integrally by internal and external threads, and the light permeable frame 50 and the shade 60 are combined integrally by internal and external threads.

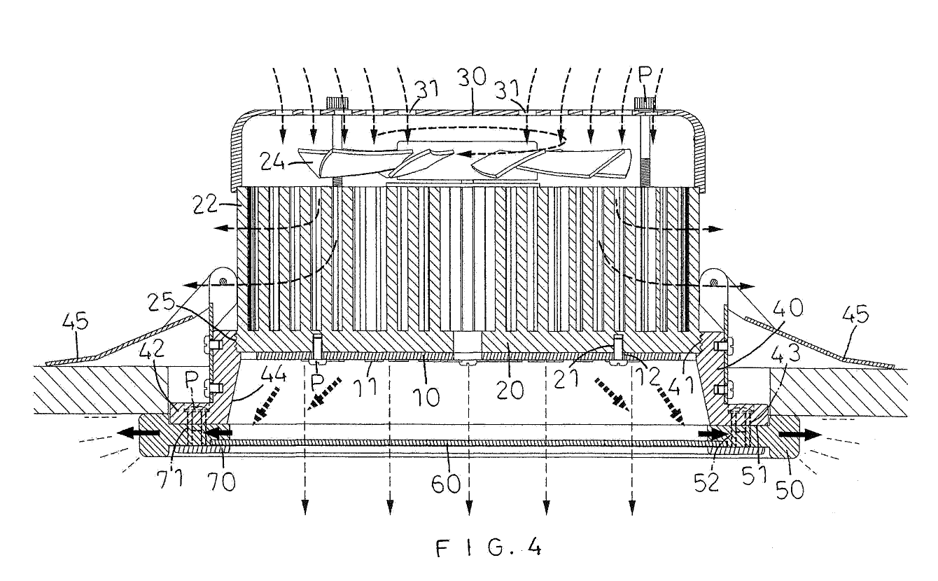

In operation, referring to FIG. 4 with reference to FIGS. 1-3, the light rays of the primary LED lights 11 permeate through the shade 60 and irradiate downward in a perpendicular manner. At the same time, the light rays of the primary LED lights 11 are guided by the light guide face 44 of the mounting seat 40, pass through the light permeable frame 50 and are diffused and emitted sideward from the shade 60 in an angle of one hundred and eighty degrees (180°) so as to expand the illuminating angle and range of the primary LED lights 11.

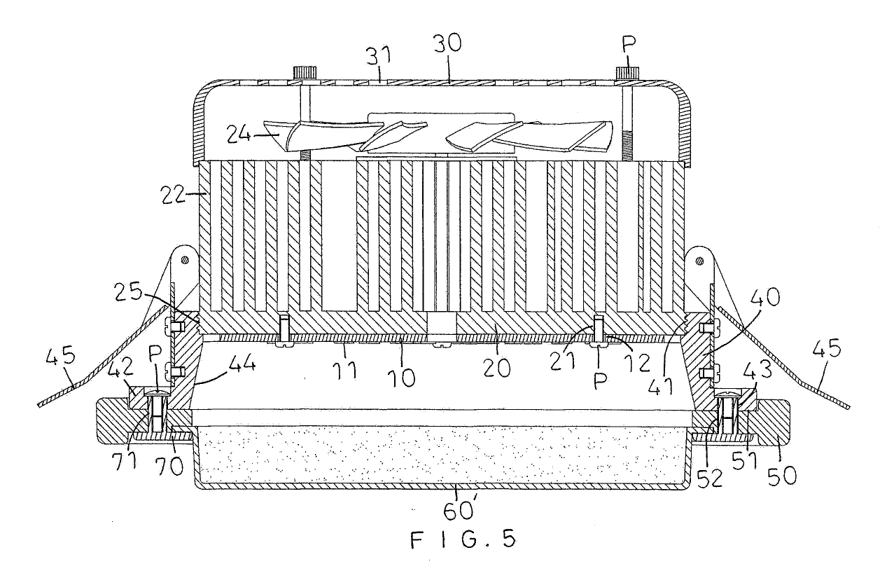

Referring to FIG. 5, the shade 60′ has a cylindrical shape.

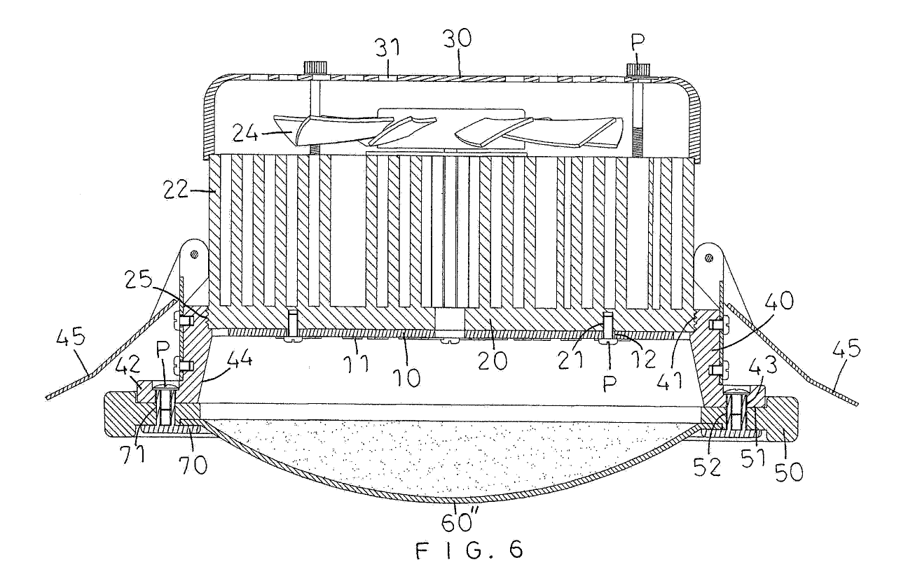

Referring to FIG. 6, the shade 60″ has a spherical shape.

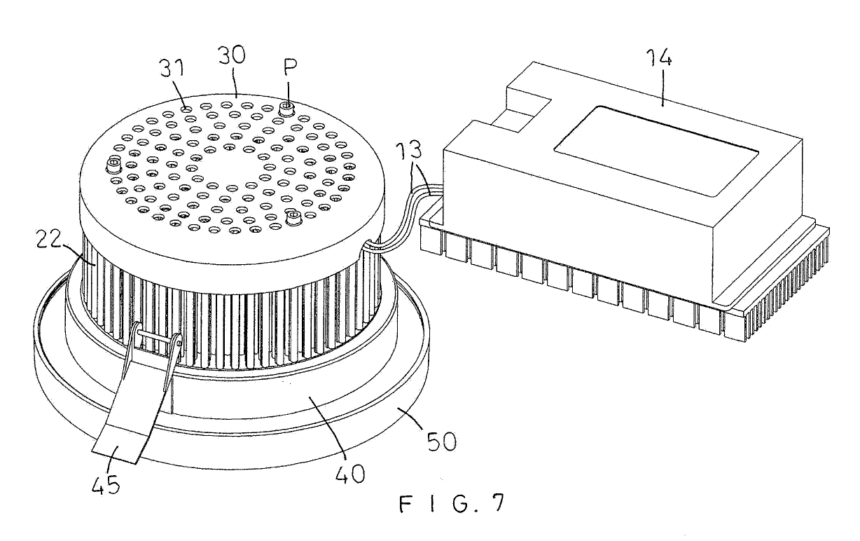

Referring to FIG. 7, the mounting seat 40 and the light permeable frame 50 are combined integrally by internal and external threads, and the light permeable frame 50 and the shade 60 are combined integrally by internal and external threads. Thus, it is unnecessary to mount the lower cap 70.

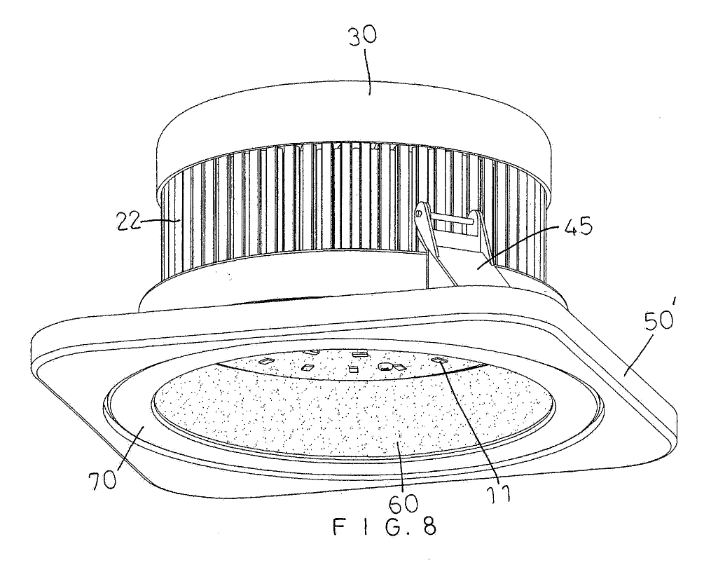

Referring to FIG. 8, the light permeable frame 50′ has a rectangular shape.

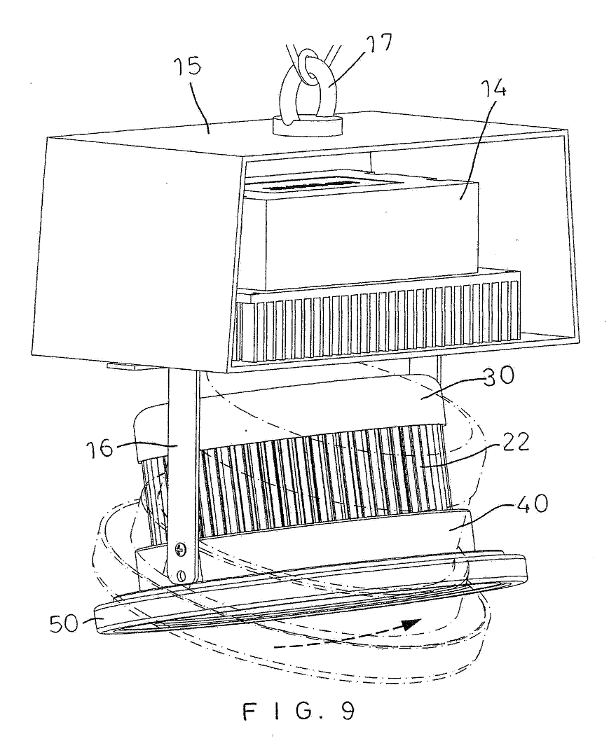

Referring to FIG. 9, the LED lamp further comprises a support rack 15 mounted on a top of the mounting seat 40, and a hanging ring 17 mounted on a top of the support rack 15. The LED driver 14 is received in the support rack 15. The support rack 15 is provided with two suspension arms 16 pivotally mounted on the mounting seat 40 by two screws, so that the mounting seat 40 is pivoted relative to the support rack 15 to adjust the illuminating angle. The two suspension arms 16 replace the two elastic plates 45. Thus, the LED lamp is available for a factory, a gas station, a stadium and the like.

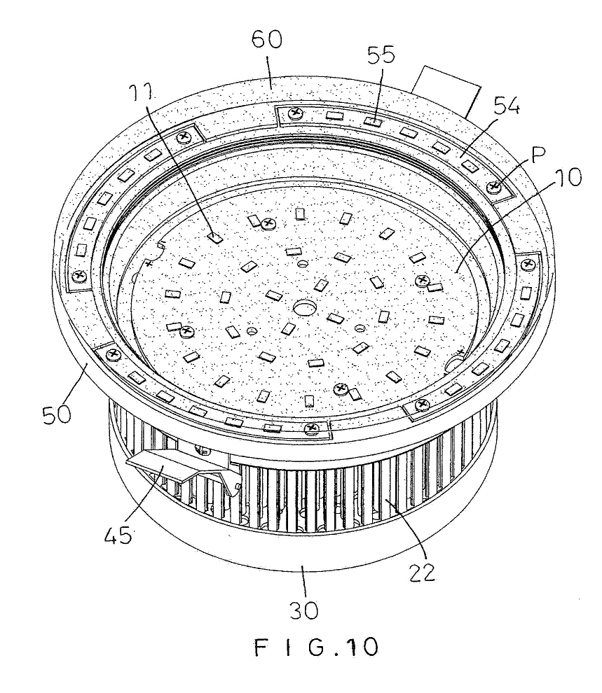

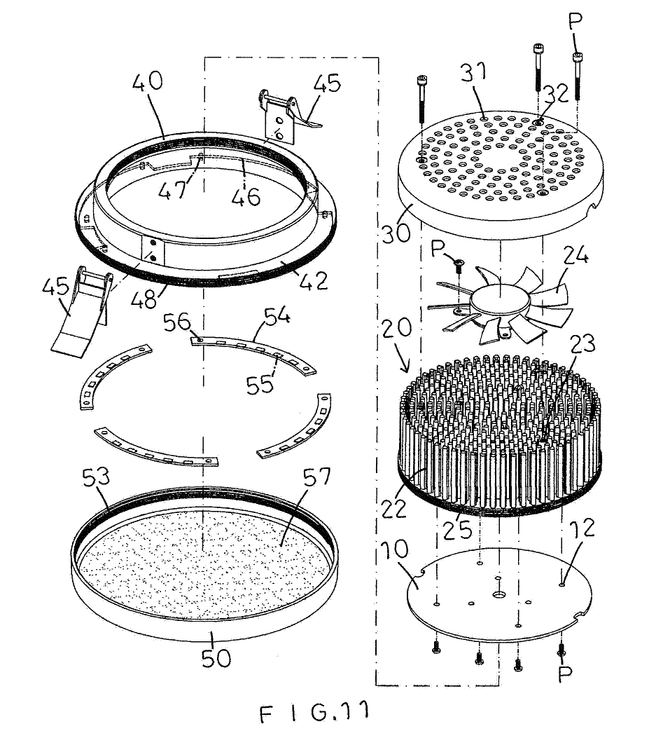

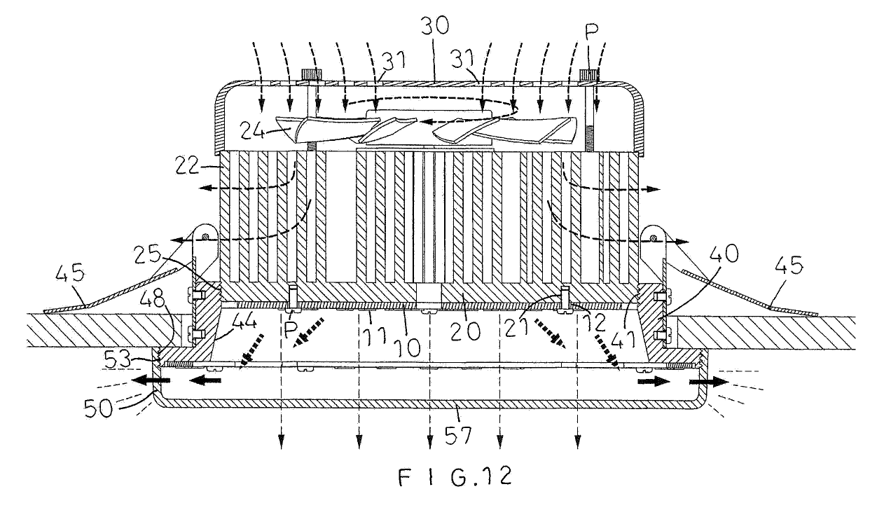

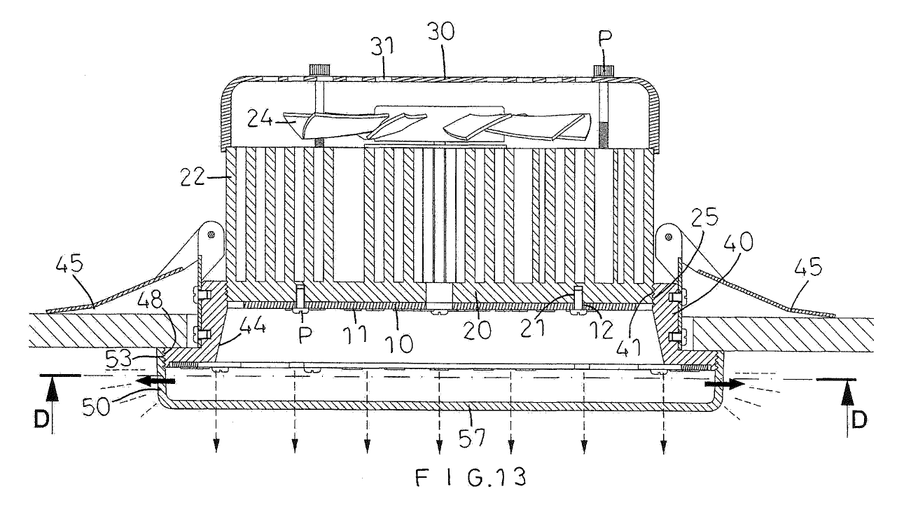

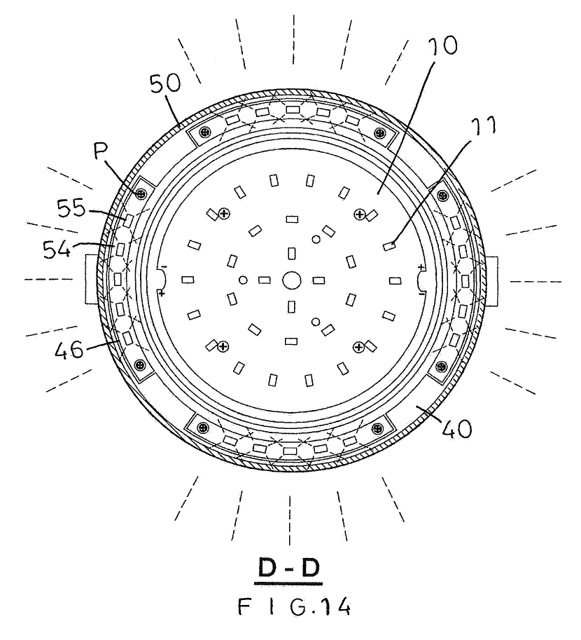

Referring to FIGS. 10-14, the mounting seat 40 is provided with a plurality of arc-shaped slots 46 corresponding to the light guide face 44, and the LED lamp further comprises a plurality of arc-shaped secondary circuit boards 54 mounted in the slots 46 of the mounting seat 40. Each of the slots 46 of the mounting seat 40 is provided with two screw bores 47. Each of the secondary circuit boards 54 is provided with two through holes 56. The secondary circuit boards 54 are arranged in an annular shape. Each of the secondary circuit boards 54 is locked in each of the slots 46 of the mounting seat 40 by two screws “P” which extend through the two through holes 56 and are screwed into the two screw bores 47. Each of the secondary circuit boards 54 is provided with a plurality of secondary LED lights 55. Thus, when the primary LED lights 11 are turned off, the secondary LED lights 55 are turned on to function as night lights. The mounting seat 40 has an outer periphery provided with an external thread 48. The light permeable frame 50 has an inner periphery provided with an internal thread 53 screwed onto the external thread 48 of the mounting seat 40. The light permeable frame 50 has a bottom face integrally formed with a translucent planar shade 57 which is formed with foggy or matted face by a dispersant.

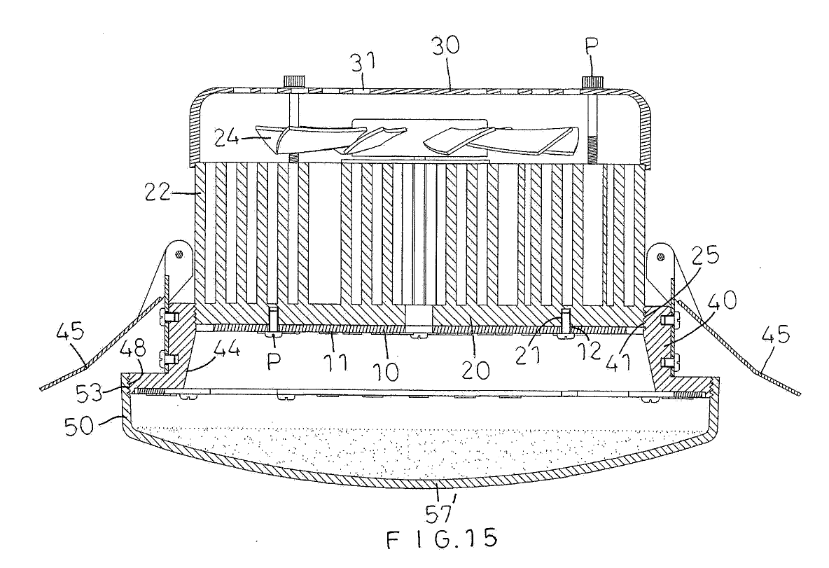

Referring to FIG. 15, the shade 57′ has a spherical shape.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An LED lamp comprising:
a mounting seat having a hollow portion;
a circuit board mounted in the hollow portion of the mounting seat;
a plurality of primary LED lights mounted on a bottom of the circuit board;
a light permeable frame mounted on a periphery of the mounting seat; and
a shade mounted on a bottom face of the light permeable frame;
wherein:
the mounting seat is provided with an outer stepped face;
the mounting seat has a bottom provided with a light guide face corresponding to an inner peripheral face of the light permeable frame;
the light permeable frame is provided with an inner stepped face secured on the outer stepped face of the mounting seat;
the light rays of the primary LED lights permeate through the shade and irradiate downward in a perpendicular manner; and
the light rays of the primary LED lights are guided by the light guide face of the mounting seat, pass through the light permeable frame and are diffused and emitted sideward from the shade in an angle of one hundred and eighty degrees (180°) to expand the illuminating angle and range of the primary LED lights.

2. The LED lamp of claim 1, further comprising:
a radiator mounted on a top of the circuit board; and
a heat radiating fan mounted on the radiator;
wherein:
the radiator includes a plurality of heat radiating columns and a plurality of threaded columns;
the heat radiating fan is locked onto the threaded columns of the radiator by a plurality of screws which extend through the heat radiating fan and are screwed into the threaded columns of the radiator; and
the heat energy produced by the circuit board is conducted quickly by the heat radiating columns of the radiator and the hot air is blown outward by the heat radiating fan.

3. The LED lamp of claim 2, further comprising:
an air inlet ornament cover mounted on the radiator;
wherein:
the air inlet ornament cover is provided with a plurality of through holes corresponding to the threaded columns of the radiator;
the air inlet ornament cover is locked onto the threaded columns of the radiator by a plurality of screws which extend through the through holes of the air inlet ornament cover and are screwed into the threaded columns of the radiator; and
the air inlet ornament cover has a surface provided with a plurality of air inlet holes corresponding to the heat radiating fan, so that the heat radiating fan draws ambient cold air through the air inlet holes of the air inlet ornament cover and blows the hot air outward.

4. The LED lamp of claim 1, further comprising:
two elastic plates pivotally mounted on two opposite sides of the mounting seat;
wherein:
the mounting seat is attached to a support member by the two elastic plates.

5. The LED lamp of claim 1, further comprising:
a support rack mounted on a top of the mounting seat; and
a hanging ring mounted on a top of the support rack;
wherein:
the circuit board is connected with an LED driver;
the LED driver is received in the support rack; and
the support rack is provided with two suspension arms pivotally mounted on the mounting seat, so that the mounting seat is pivoted relative to the support rack.

6. The LED lamp of claim 1, wherein the light permeable frame is selectively made of light permeable material of acrylic PC.

7. The LED lamp of claim 1, wherein the light permeable frame has a bottom face integrally formed with a translucent planar shade which is formed with foggy face by a dispersant.

8. The LED lamp of claim 1, wherein:
the mounting seat is provided with a plurality of slots corresponding to the light guide face;
the LED lamp further comprises a plurality of secondary circuit boards mounted in the slots of the mounting seat;
each of the slots of the mounting seat is provided with two screw bores;
each of the secondary circuit boards is provided with two through holes;
each of the secondary circuit boards is locked in each of the slots of the mounting seat by two screws which extend through the two through holes and are screwed into the two screw bores;
each of the secondary circuit boards is provided with a plurality of secondary LED lights; and
when the primary LED lights are turned off, the secondary LED lights are turned on to function as night lights.

9. The LED lamp of claim 1, wherein the shade has a planar shape, a cylindrical shape or a spherical shape.

10. The LED lamp of claim 1, further comprising:
a lower cap mounted on a bottom of the shade;
wherein:
the outer stepped face of the mounting seat is provided with a plurality of through holes;
the inner stepped face of the light permeable frame is provided with a plurality of apertures corresponding to the through holes of the mounting seat;
the lower cap has a hollow portion and is provided with a plurality of threaded tubes extending through the apertures of the light permeable frame; and
a plurality of screws extend through the through holes of the mounting seat and are screwed into the threaded tubes of the lower cap, to integrally combine the mounting seat, the light permeable frame, the shade and the lower cap.

11. The LED lamp of claim 1, wherein:
the outer stepped face of the mounting seat and the inner stepped face of the light permeable frame are combined integrally by internal and external threads; and
the light permeable frame and the shade are combined integrally by internal and external threads.
